(19) United States
(12) Patent Application Publication
(10) Pub. No.: US 2012/0155345 A1
(43) Pub. Date: Jun. 21, 2012

(54) COMMUNICATION DEVICE

(75) Inventors: Hiroki MORI, Kawasaki-shi (JP); Tsuguhide Aoki, Kawasaki-shi (JP); Yuji Tohzaka, Kawasaki-shi (JP); Yasuhiko Tanabe, Kawasaki-shi (JP)

(73) Assignee: KABUSHIKI KAISHA TOSHIBA, Tokyo (JP)

(21) Appl. No.: 13/335,507

(22) Filed: Dec. 22, 2011

Related U.S. Application Data
(63) Continuation of application No. PCT/JP2009/002911, filed on Jun. 25, 2009.

(51) Int. Cl. H04B 7/04

(52) U.S. Cl. 370/310

(57) ABSTRACT

In one embodiment, there is provided a communication device configured to add a first perturbation signal corresponding to an integer multiple of a first basic signal, to a first information signal having first information, which is to be transmitted to a plurality of destination terminals, and transmit a wireless signal having the first information to the plurality of destination terminals by a spatial multiplexing method. The device includes: a determination unit configured to set a magnitude of the first basic signal to N times of one side of a basic lattice, wherein the basic lattice is determined according to a modulation method of the first information signal, and N is real number of one or more; an adder configured to add the first perturbation signal to the first information signal to output a second information signal; and a multiplier configured to multiply the second information signal by a weight.

### CROSS-REFERENCE TO RELATED APPLICATION

This is a Continuation Application of PCT Application No. PCT/JP2009/00291 1, filed on Jun. 25, 2009, which was published under PCT Article 21(2) in Japanese, the entire contents of which are incorporated herein by reference.

### BACKGROUND

1. Field

Embodiments described herein relate to a wireless communication device.

2. Description of the Related Art

A spatial division multiple access (SDMA) method is known in which a base station performs communication (spatially multiplexing) on a plurality of terminals (hereinafter, referred to as a user terminal: a communication device capable of receiving a wireless signal) at the same time and in the same frequency band. In the SDMA method, the user terminal (reception side) of a reception destination is prevented from simultaneously receiving a signal transmitted to the user terminal (itself) of the reception destination and a signal transmitted to the other user terminal, from the base station (transmission side) (hereinafter, referred to as occurrence of interference between user terminals).

In a ZF (Zero-Forcing) method, a base station prevents interference between user terminals by multiplying a transmission signal by a pseudo inverse matrix of a channel matrix as a weight. The channel matrix is a matrix in which channel coefficients representing a propagation path state between each of a plurality of transmission antennas of the base station and each of a plurality of reception antennas of user terminals are elements. When spatial correlation of the channel matrix is high and the base station performs the multiplication of the weight using the pseudo inverse matrix of the channel matrix, a signal level (transmission power) of the transmission signal is increased. For this reason, the base station further multiplies the transmission signal by a normalization coefficient such that the transmission power falls within rated power. In the ZF method, since power loss of the transmission signal occurs by the multiplication of the normalization coefficient, a noise is emphasized in the user terminal as large as a reciprocal number of the normalization coefficient (1√γ), and reception performance (for example, a bit error rate, a frame error rate, and a throughput) deteriorates.

In a VP (Vector Perturbation) method, a base station adds a perturbation vector to a transmission signal such that a reciprocal number of a normalization coefficient is the minimum. Then, the base station multiplies the transmission signal, to which the perturbation vector is added, by the weight and the normalization coefficient in the same manner as the ZF method. The user terminal removes the same perturbation vector as the perturbation vector added in the base station, from the reception signal, and demodulates the reception signal. In such a manner, in the VP method, it is possible to improve communication capacity (channel capacity) of a frequency band.

In addition, even in the VP method, the reception performance deteriorates for the same reason as the ZF method, but it is possible to reduce the reciprocal number of the normalization coefficient as compared with the ZF method, and thus it is possible to suppress the deterioration of the reception performance.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 is a diagram illustrating a communication device;

FIG. 2 is a diagram illustrating a communication device;

FIG. 3 is a diagram illustrating a modulo operation;

FIG. 4 is a diagram illustrating a modulo operation;

FIG. 5 is a diagram illustrating a Look-Up table;

FIG. 6 is a diagram illustrating a Look-Up table;

FIG. 7 is a diagram illustrating characteristics of a packet error rate; and

FIG. 8 is a diagram illustrating characteristics of a packet error rate.

### DETAILED DESCRIPTION

According to an embodiment, there is provided a communication device configured to add a first perturbation signal corresponding to an integer multiple of a first basic signal, to a first information signal having first information, which is to be transmitted to a plurality of destination terminals, and transmit a wireless signal having the first information to the plurality of destination terminals by a spatial multiplexing method. The device includes: a determination unit configured to set a magnitude of the first basic signal to N times of one side of a basic lattice, wherein the basic lattice is determined according to a modulation method of the first information signal, and N is real number of one or more; an adder configured to add the first perturbation signal to the first information signal to output a second information signal; and a multiplier configured to multiply the second information signal by a weight.

Hereinafter, exemplary embodiments of the invention will be described.

### First Embodiment

### Transmission Side Communication Device

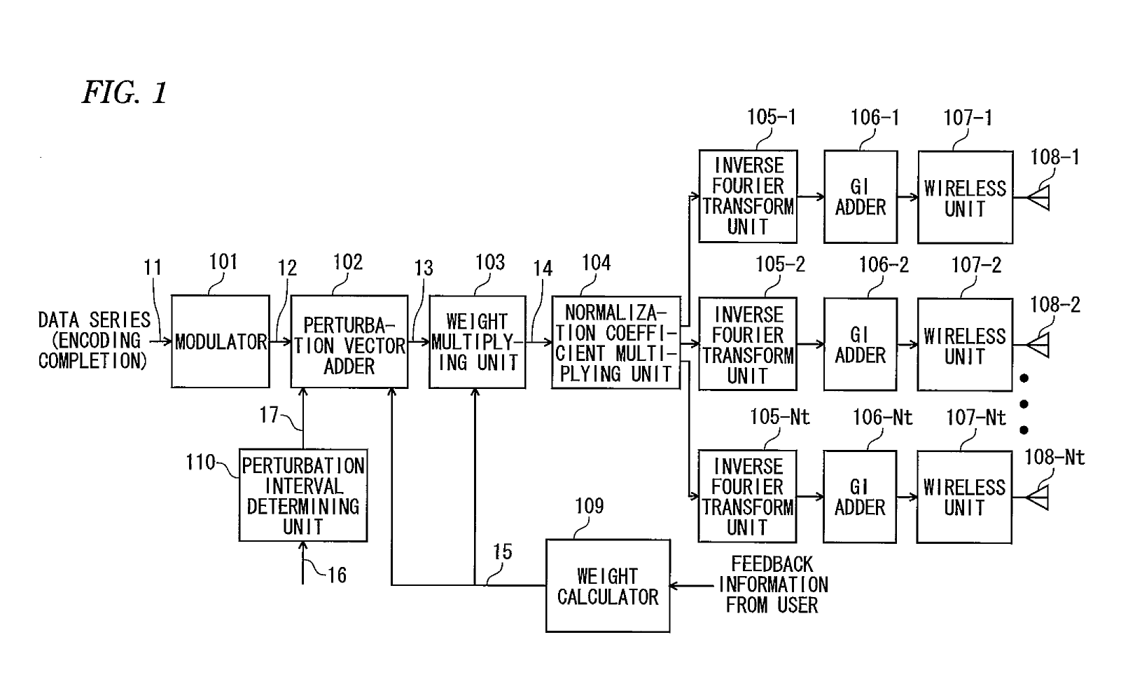

FIG. 1 is a diagram illustrating a communication device (transmission side) AP according to a first embodiment. The communication device AP includes a modulator 101, a perturbation vector adder 102, a weight multiplying unit 103, a normalization coefficient multiplying unit 104, Nt (Nt is an integer equal to or more than 1: Nt indicates the number of antennas of the communication device) inverse fast Fourier transform (IFFT) units 105-1, . . . , 105-Nt, GI (guard interval) adders 106-1, . . . , 106-Nt, Nt wireless units 107-1, . . . , 107-Nt, and Nt antennas 108-1, . . . , 108-Nt. The communication device AP is, for example, a base station. The communication device AP transmits a wireless signal to a plurality of communication devices STA (reception side: for example, user terminals) in a spatial multiplexing method (SDMA method) in the same time band and the same frequency band using the antennas 108-1, . . . , 108-Nt.

The modulator 101 performs a modulation process on a data series 11 encoded by an encoding unit (not shown). The modulator generates a data signal 12 that is a modulation symbol from the data series 11. The modulator 101 outputs the data signal 12 to the perturbation vector adder 103. The modulation method of the modulator 101 may be a modulation method in which the user terminal that is a communication target can demodulate. For example, the modulation method may be a PSK (phase shift keying) method such as BPSK (binary phase shift keying) and QPSK (quadrature phase shift keying), and may be a QAM method such as 16QAM (quadrature amplitude modulation), 64QAM, and 256QAM.

The perturbation vector adder 102 determines a perturbation vector added to the data signal 12 on the basis of the data signal 12 from the modulator 101, the weight matrix 15 from the weight calculator 109, and the perturbation interval information 17 from the perturbation interval determining unit 110. The perturbation vector is integer multiple of the basic signal determined by the perturbation interval. In the perturbation vector adder 102, a method of determining whether to set the perturbation vector added to the data signal 12 to be N times of the basis signal may be any method, it may be determined such that the reciprocal number of the normalization coefficient is the minimum, and it may be determined such that the reciprocal number of the normalization coefficient is the minimum after a search range is restricted. The perturbation vector adder 102 adds the perturbation vector to the data signal 12. The perturbation vector adder 102 outputs the data signal 13 to which the perturbation vector addition is completed, to the weight multiplying unit 103.

The weight multiplying unit 103 multiplies the weight matrix 15 calculated by the weight calculator 109 from the weight calculator 109 by the data signal from the perturbation vector adder 103. The weight multiplying unit 103 outputs the weight-multiplied data signal 14 to the normalization coefficient multiplying unit 104.

The normalization coefficient multiplying unit 104 multiplies the data signal 14 from the weight multiplying unit 103 by the normalization coefficient such that the total transmission power falls within a regulation value. The normalization coefficient multiplying unit 104 outputs the normalization coefficient-multiplied data signals to the IFFT units 105-1, . . . , 105-Nt.

The IFFT units 105-1, . . . , 105-Nt perform the IFFT process on the data signal from the normalization coefficient multiplying unit 104, and converts a signal in a frequency area into a signal in a time area. The IFFT units 105-1, . . . , 105-Nt output the converted signals to the GI adder 106-1, . . . , 106-Nt, respectively.

The GI adders 106-1, . . . , 106-Nt add GI to the signals from the IFFT units 105-1, . . . , 105-Nt. The GI adders 106-1, . . . , 106-Nt output the GI-added signals to the wireless units 107-1, . . . , 107-Nt, respectively. The adding method of the GI adders 106-1, . . . , 106-Nt may be any method, which is usable in an orthogonal frequency division multiplexing (OFDM) method or an orthogonal frequency division multiple access (OFDMA) method.

Herein, the IFFT units 105-1, . . . , 105-Nt and the GI adders 106-1, . . . , 106-Nt are not essential constituent elements. When the communication device AP performs multi-carrier transmission such as OFDM and OFDMA, the IFFT units 105-1, . . . , 105-Nt and the GI adders 106-1, . . . , 106-Nt are necessary. When the communication device AP performs single-carrier transmission, they are unnecessary. When the communication device AP performs the single-carrier transmission, the data signals from the normalization coefficient multiplying unit 104 are directly input to the wireless units 107-1, . . . , 107-Nt. Even when the communication device AP performs any one of the multi-carrier transmission and the single-carrier transmission, a digital filter for band restriction may be provided at the front stage of the wireless units 107-1, . . . , 107-Nt.

The wireless units 107-1, . . . , 107-Nt perform a transmission process on the GI-added signals. The wireless units 107-1, . . . , 107-Nt perform digital-analog conversion (DA conversion) based on a digital-analog converter (digital-to-analog converter: DAC), up conversion based on a frequency converter, or power amplification based on a power amplifier, on the GI-added signals. The wireless units 107-1, . . . , 107-Nt output the transmission-processed wireless signals to the antennas 108-1, . . . , 108-Nt, respectively.

The antennas 108-1, . . . , 108-Nt emit the wireless signals from the wireless units 107-1, . . . , 107-Nt to a space, respectively. The antennas 108-1, . . . , 108-Nt are not limited to a specific antenna, preferably, an antenna capable of transmitting a wireless signal in a desired frequency band.

The weight calculator 109 calculates the weight matrix 15 using feedback information from the reception side communication device STA. The weight calculator 109 outputs the weight matrix 15 to the perturbation vector adder 102 and the weight multiplying unit 103. The method of calculating the weight matrix 15 by the weight calculator 109 is appropriately selected according to the feedback information. For example, when the feedback information is a channel response between the communication device AP and the communication device STA, the weight calculator 109 calculates the weight matrix 15 using ZF norm or MMSE (Minimum Mean Square Error) norm. When the feedback information is an index selected from a codebook shared in advance between the communication device AP and the user terminal, the weight calculator 110 refers the codebook from the index and can calculate the weight matrix 15. The code book may be configured by vector (for example, weight vector and propagation path response vector) in an orthogonal relation, and may be configured by vector in a non-orthogonal relation.

The perturbation interval determining unit 110 determines the perturbation interval information 17 on the basis of the perturbation interval determining signal 16. The perturbation interval determining signal 16 and the method of determining the perturbation interval information 17 by the perturbation interval determining unit 110 will be described in detail. The perturbation interval determining unit 109 inputs the perturbation interval information 17 to the perturbation vector adder 102.

<Reception Side Communication Device>

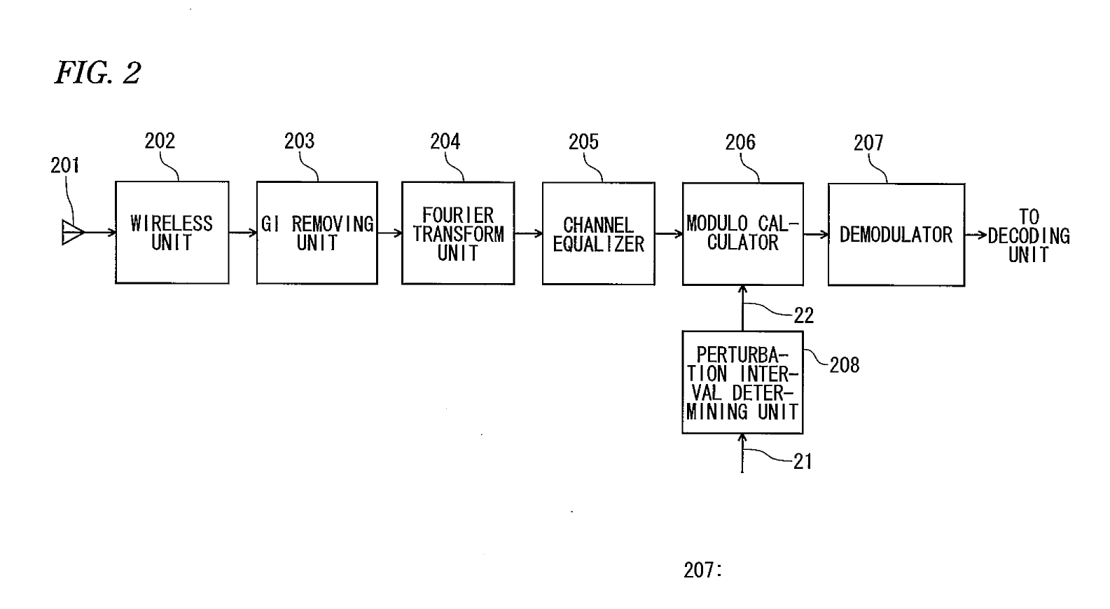

FIG. 2 is a diagram illustrating a communication device (reception side) STA according to a first embodiment. The communication device STA includes an antenna 201, a wireless unit 202, a GI removing unit 203, a fast Fourier transform (FFT) unit 204, a channel equalizer 205, a modulo operating unit 206, a demodulator 207, and a perturbation interval determining unit 208. The communication device STA is, for example, a user terminal communicating with the base station.

The antenna 201 receives the wireless signal transmitted from the communication device AP. The received wireless signal (reception signal) is input to the wireless unit 202 through the antenna 201. The antenna 201 is not limited to a specific antenna, and preferably, is an antenna capable of receiving a wireless signal in a desired frequency band.

The wireless unit 202 performs a reception process on the reception signal from the antenna 201. The wireless unit 202 performs amplification of a signal level based on a low noise amplifier (LNA), down conversion based on a frequency converter, analog-digital conversion (AD conversion) based on an analog-digital convertor (ADC), band restriction based on a filter, and the like, on the reception signal. The wireless unit 202 outputs a baseband signal after performing such a signal process, to the GI removing unit 203.

The GI removing unit 203 removes the GI from the baseband signal output from the wireless unit 202. The GI removing unit 203 outputs the GI-removed signal to the Fourier transform unit 204. Herein, the method of removing the GI by the GI removing unit 203 may be any method, and may be a method usable in the OFDM method or the OFDMA method.

The Fourier transform unit 204 performs the FFT on the GI-removed baseband signal, and converts the signal in a time area into a signal in a frequency area. The Fourier transform unit 204 separate the GI-removed baseband signal for each sub-carrier. The Fourier transform unit 204 outputs the data signal 21 of the signals after the FFT to the channel equalizer 205, and outputs a pilot signal 22 to a channel estimating unit (not shown).

Herein, the GI removing unit 203 and the Fourier transform unit 204 are not essential constituent elements. When the communication device AP performs the multi-carrier transmission such as OFDM and OFDMA, the GI removing unit 203 and the Fourier transform unit 24 are necessary. When the communication device AP performs single-carrier transmission, they are unnecessary. When the communication device AP performs the single-carrier transmission, the baseband signal from the wireless unit 202 is directly input to the channel equalizer 205. Even when the communication device AP performs any one of the multi-carrier transmission and the single-carrier transmission, a digital filter for band restriction may be provided at the rear stage of the wireless unit 202.

The channel equalizer 205 performs channel equating, on the input data signal, using an effective channel estimated by the pilot signal or an effective channel reported using a signal other than the data signal such as the header signal from the communication device AP. The channel equalizer 205 outputs the channel-equated data signal to the modulo operating unit 206.

The modulo operating unit 206 performs the modulo operation on the data signal output from the channel equalizer 205 using the perturbation interval information 22 from the perturbation interval determining unit 208, and removes the perturbation vector (integer multiple of the basic signal) added to the data signal. The modulo operating unit 206 acquires the basic signal of the perturbation vector from the perturbation interval information 22. The modulo operating unit 206 restores the data signal 12 before the perturbation vector is added by the perturbation vector adder 102. The modulo operating unit 206 outputs the modulo-operated data signal to the demodulator 207.

The modulator 207 performs the demodulation process on the data signal from the modulo operating unit 206 to generate a data series. The demodulation process corresponds to the modulation process used by the communication device AP. The data series output by the demodulator 207 is subjected to the demodulation process corresponding to the encoding process of the communication device AP by the demodulator (not shown).

The perturbation interval determining unit 208 determines the perturbation interval information 22 on the basis of the perturbation interval determining signal 21. The perturbation interval determining signal 21 and the method of determining the perturbation interval information 22 by the perturbation interval determining unit 208 will be described in detail. The perturbation interval determining unit 208 inputs the perturbation interval information 22 to the modulo operating unit 206.

<ZF Method>

Hereinafter, the ZF method in which the communication devices AP and STA use a part of the technique thereof will be described. In addition, in the following description, it is assumed that wireless communication based on SDMA is performed between the base station and the user terminals 1 and 2.

The base station has two transmission antennas Tx1 and Tx2. The user terminal 1 has one reception antenna Rx1. The user terminal 2 has one reception antenna Rx2. The base station transmits a data signal s represented in the following formula (I) to the user terminal 1 and the user terminal 2.

$$s = [ \begin{matrix}{s}_{1} \\ {s}_{2}\end{matrix} ] \qquad ( 1 )$$

In Formula 1, S₁ indicates a data signal for the user terminal 1, and S₂ indicates a data signal for the user terminal 2. When the reception antenna Rx1 and the reception antenna Rx2 receive the data signals s, a noise signal n shown in Formula 2 is superposed (added) to the data signal s.

$$n = [ \begin{matrix}{n}_{1} \\ {n}_{2 }\end{matrix} ] \qquad ( 2 )$$

In Formula 2, n₁ indicates a noise signal received by the reception antenna Rx1, and n₂ indicates a noise signal received by the reception signal Rx2. The reception signals y of the reception antenna Rx1 of the user terminal 1 and the reception antenna Rx2 of the user terminal 2 are as shown in Formula 3.

$$\begin{matrix}y = Hs + n \\ = [ \begin{matrix}{h}_{11} & {h}_{12} \\ {h}_{21} & {h}_{22}\end{matrix} ] [ \begin{matrix}{s}_{1} \\ {s}_{2 }\end{matrix} ] + [ \begin{matrix}{n}_{1} \\ {n}_{2}\end{matrix} ]\end{matrix} \qquad ( 3 )$$

In Formula 3, H is a channel matrix between the base station and the user terminal 1 and the user terminal 2. Herein, h₁₁ is a channel response between the transmission antenna Tx1 and the reception antenna Rx1, h₁₂ is a channel response between the transmission antenna Tx2 and the reception antenna Rx1, h₂₁ is a channel response between the transmission antenna Tx1 and the reception antenna Rx2, and h₂₂ is a channel response between the transmission antenna Tx2 and the reception antenna Rx2. As shown in Formula 3, interference caused by the data signal s₂ for the user terminal 2 occurs in the reception signal of the reception antenna Rx1 of the user terminal 1. Interference caused by the data signal s₁ for the user terminal 1 occurs in the reception signal of the reception antenna Rx2 of the user terminal 2. The base station multiplies the signal s by the weight matrix W shown in Formula 4 in advance to prevent the interference from occurring.

W=W=H⁺=H^{H}(HH^{H})⁻¹ (4)

In Formula 4, H⁺ indicates a normalization inverse matrix of the channel matrix H, and H^{H} indicates a complex conjugation transpose matrix of the channel matrix H. When the spatial correlation of the channel matrix H is large, there is a problem of increase of transmission power of the transmission signal from the base station by multiplying the weight matrix. In the ZF method, the base station further multiplies the normalization coefficient shown in Formula 5 by the data signal s after multiplying the weight matrix W such that the transmission power falls within rated transmission power, to generate the transmission signal x.

$$x = \frac{1}{\sqrt{γ}} Ws \qquad ( 5 )$$

In Formula 5, y is calculated by, for example, Formula 6.

γ=∥Ws∥² (6)

The normalization (Formula 5) shown in Formula 6 is performed to realize normalization in which the total transmission power of the transmission signal x is “1”. When the reception antenna Rx1 of the user terminal 1 and the reception antenna Rx2 of the user terminal 2 receive the transmission signal x (Formula 6) transmitted from the base station, a reception signal y shown in Formula 7 is obtained.

$$\begin{matrix}y = \frac{1}{\sqrt{γ}} HWs + n \\ = \frac{1}{\sqrt{γ}} {{HH}^{H} ( {HH}^{H} )}^{- 1} s + n \\ = \frac{1}{\sqrt{γ}} s + n \\ = \frac{1}{\sqrt{γ}} [ \begin{matrix}{s}_{1} \\ {s}_{2}\end{matrix} ] + [ \begin{matrix}{n}_{1} \\ {n}_{2 }\end{matrix} ]\end{matrix} \qquad ( 7 )$$

In Formula 7, an effective channel (1√r) is multiplied by the data signals s (s₁ and s₂), and thus the user terminal 1 and the user terminal 2 perform the channel equating of the reception signal y using the estimated effective channel using the pilot signal or the estimated effective channel H_{eff} reported by a signal (for example, header signal) other than the data signal from the base station, and obtain a reception signal y′ after the channel equating shown in Formula 8.

$$\begin{matrix}{y}^{′} = \frac{y}{{H}_{eff}} \\ = [ \begin{matrix}{s}_{1} \\ {s}_{2 }\end{matrix} ] + \sqrt{γ} [ \begin{matrix}{n}_{1} \\ {n}_{2 }\end{matrix} ]\end{matrix} \qquad ( 8 )$$

As shown in Formula 8, the user terminal 1 and the user terminal 2 can receive the user signal S₁ for the user terminal 1 and the user signal s₂ for the user terminal 2 without interference from each other, respectively. However, the user terminal 1 and the user terminal 2 receive a noise component n₁ emphasized by √r times (that is, reciprocal times of the normalization coefficient) and a noise component n₂ emphasized by √r times. Accordingly, the ZF method has a problem that the noise component n₁ and the noise component n₂ are emphasized as the normalization coefficient (1/√r) gets smaller, and the reception performance of the user terminal 1 and the user terminal 2 deteriorates.

<VP Method>

Hereinafter, the VP method (for example, NPL 1) in which the communication devices AP and STA use a part of the technique thereof will be described. As shown in Formula 9, the VP method is different from the ZF method in that the base station adds a perturbation vector τ1 to a user signal s to generate a transmission signal x.

$$x = \frac{1}{\sqrt{γ}} W ( s + τ l ) \qquad ( 9 )$$

In Formula 9, γ to set the total transmission power of the transmission signal x to “1” is calculated using Formula 10.

γ=∥W(s+τl)∥² (10)

In the VP method, the base station determines the perturbation vector τl in which the γ shown in Formula 10 is the minimum according to the norm shown in Formula 11.

$$l = {argmin}_{\hat{l} ∈ {ℂℤ}^{K}} {‖ W ( s + τ \hat{l} ) ‖}^{2} \qquad ( 11 )$$

In Formula 11, K indicates the number of users who spatially multiplex using the SDMA, and CZ^{K} indicates a K-dimensional vector in which both components of a real part and an imaginary part are integer values. Any one of various search methods such as sphere encoding method described in NPL 1 and LLL algorithm described in NPL 2 may be used in the determination of the perturbation vector 1.

In Formula 11, τ indicates a perturbation interval (basic signal). The τ is set from the modulation method performed on the user signal s. For example, in related art documents, an example of setting τ by Formula 18 is described.

$$τ = 2 ( {\vert c \vert}_{ma x} + \frac{Δ}{2} ) \qquad ( 18 )$$

|c|ₘₐₓ indicates the maximum value on a real axis or an imaginary axis of a constellation given for each modulation method, and Δ indicates a distance between signal points in the constellation. In the case of QPSK (having a constellation based on the signal points of values (1, 1), (1, −1), (−1, 1), and (−1, −1) on the real axis and the imaginary axis), |c|ₘₐₓ is “1”, Δ is “2”, and thus τ is set to “4”. In the case of 16QAM (having a constellation obtaining signal points at intersections between values on the real axis {−3, −1, 1, 3} and value on the imaginary axis {−3, −1, 1, 1}), |c|ₘₐₓ is “3”, Δ is “2”, and thus τ is set to “8”.

When the reception antenna Rx1 of the user terminal 1 and the reception antenna Rx2 of the user terminal 2 receive the transmission signal x (Formula 9) from the base station, the reception signal y shown in Formula 12 is obtained. The component of the perturbation vector τl is divided into τl₁ and τl₂.

$$\begin{matrix}y = \frac{1}{\sqrt{γ}} HW ( s + τ l ) + n \\ = \frac{1}{\sqrt{γ}} {{HH}^{H} ( {HH}^{H} )}^{- 1} ( s + τ l ) + n \\ = \frac{1}{\sqrt{γ}} ( s + τ l ) + n \\ = \frac{1}{\sqrt{γ}} [ \begin{matrix}{s}_{1} + τ {l}_{1} \\ {s}_{2} + τ {l}_{2}\end{matrix} ] + [ \begin{matrix}{n}_{1} \\ {n}_{2 }\end{matrix} ]\end{matrix} \qquad ( 12 )$$

When the user terminal 1 and the user terminal 2 perform the ideal channel equating on the reception signal y shown in Formula 12, the reception signal y′ shown in Formula 13 is obtained by the channel equating.

$${y}^{′} = [ \begin{matrix}{s}_{1} + τ {l}_{1} \\ {s}_{2} + τ {l}_{2}\end{matrix} ] + \sqrt{γ} [ \begin{matrix}{n}_{1} \\ {n}_{2 }\end{matrix} ] \qquad ( 13 )$$

In Formula 13, when neglecting the noise signal, the user terminal I receives a synthetic signal between the data signal s₁ for the user terminal 1 and the perturbation signal τl₁ added to the user signal s₁. Similarly, the user terminal 2 receives a synthetic signal between the data signal s₂ for the user terminal 2 and the perturbation signal τl₂ added to the user signal s2.

The reception signal of the user terminal 1 is obtained by shifting the signal point of the data signal s₁ for the user terminal 1 by the perturbation signal τl₁. The reception signal of the user terminal 2 is obtained by shifting the signal point of the data signal s₂ for the user terminal 2 by the perturbation signal τl₂. The user terminal 1 and the user terminal 2 perform a modulo operation shown in Formula 14 to remove the perturbation signals τl₁ and τl₂ from the reception signal y′.

$${f}_{τ} ( z ) = z - τ ⌊ \frac{z + \frac{τ}{2}}{τ} ⌋ \qquad ( 14 )$$

When the modulo operation shown in Formula 14 is applied to the receptions signal y′ shown in Formula 13, it is possible to obtain the reception signal y″ shown in Formula 15.

$$\begin{matrix}{y}^{″} = {f}_{τ} ( {y}^{′} ) \\ = [ \begin{matrix}{s}_{1} \\ {s}_{2}\end{matrix} ] + {f}_{τ} ( \sqrt{γ} [ \begin{matrix}{n}_{1} \\ {n}_{2}\end{matrix} ] )\end{matrix} \qquad ( 15 )$$

As shown in Formula 15, the user terminal 1 and the user terminal 2 remove the perturbation signals τl₁ and τl₂ from the reception signal y′ by the modulo operation shown in Formula 14 to generate the same reception signal y″ as the reception signal y′ shown in Formula 8. Difference between the reception signal y′ shown in Formula 8 and the reception signal y″ shown in Formula 15 is a magnitude of the value of γ. As described above, in the VP method, the perturbation vector τl is searched such that the γ is the minimum. Accordingly, the γ shown in Formula 15 is smaller than the γ shown in Formula 8, and in the VP method, it is possible to suppress the noise emphasis as compared with the ZF method.

Hereinafter, a problem of the VP method described above will be described. In the VP method, the reception signal y′ₖ after the channel equating in the k-th user terminal is acquired from Formula 13.

y′ₖ=sₖ+τlₖ+\sqrt{γ}nₖ (16)

The modulo operation shown in Formula 14 is equal to estimating the component lₖ of the second term of Formula 16 and subtracting the estimation result l′ₖ and the multiplication value τl'ₖ from the reception signal y′ₖ shown in Formula 16. The reception signal y″ₖ after the modulo operation is performed on the reception signal y′ₖ shown in Formula 16 becomes Formula 17.

$$\begin{matrix}{y}_{k}^{″} = {f}_{τ} ( {y}_{k}^{′} ) \\ = {s}_{k} + τ {l}_{k} + \sqrt{γ} {n}_{k} - τ {l}_{k}^{′} \\ = {s}_{k} + τ ( {l}_{k} - {l}_{k}^{′} ) + \sqrt{γ} {n}_{k}\end{matrix} \qquad ( 17 )$$

In the case of l′ₖ=lₖ from Formula 17, that is, when the k-th user terminal can accurately estimate the perturbation signal τlₖ added to the data signal sₖ for the k-th user terminal in the base station, the second term. {τ(l′ₖ−lₖ)} of Formula 17 becomes “0”, and the perturbation signal τlₖ is removed from y′ₖ.

However, when the k-th user terminal cannot accurately estimate the perturbation signal τlₖ due to a noise or the like, it becomes l′ₖ≠lₖ, and the k-th user terminal cannot remove the perturbation signal τlₖ from the reception signal y′ₖ. As a result, the demodulation process is performed on the reception signal y″ₖ from which the perturbation signal is erroneously removed, the determination of the transmission symbol is not accurately performed, and deterioration of transmission characteristics occurs. As described above, a problem that it is difficult to appropriately remove the perturbation signal added in the base station and the transmission characteristics deteriorate is called a modulo loss problem.

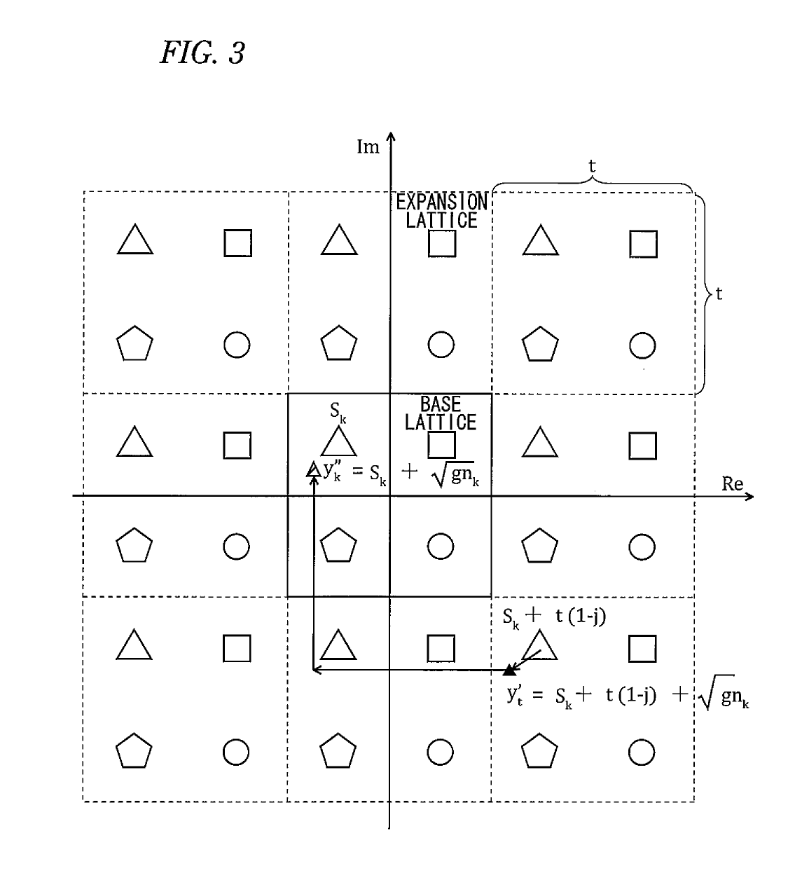

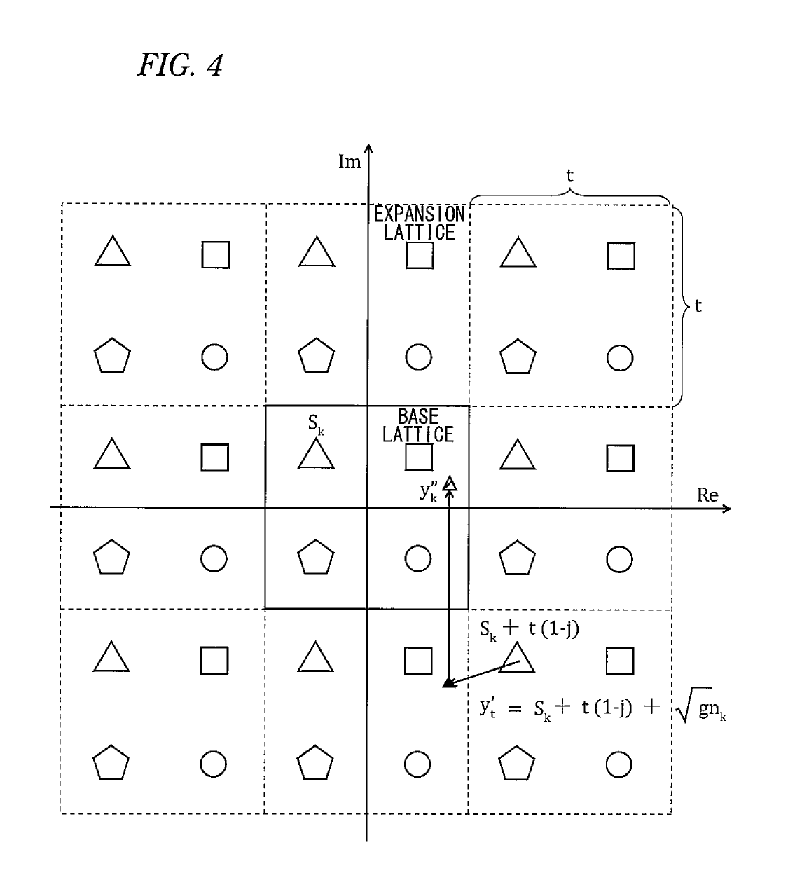

FIG. 3 and FIG. 4 are diagrams illustrating the constellation of the QPSK signal and the modulo loss problem. In the drawings, circles, triangles, rectangles, and pentagons represent candidates of signals transmitted for the k-th user terminals from the base station. An area (area surrounding the QPSK constellation of the related art) surrounded by a solid line is called a base lattice. A lattice surrounded by a broken line is called an expansion lattice. The base lattice and the expansion lattice are the same in size. The perturbation interval rt is the same as the magnitude of the basic signal, and is in the size (size of one side of the base lattice or the expansion lattice) of the base lattice or the expansion lattice, or in the distance of the center of the lattices adjacent to each other. In FIGS. 3 and 4, it is assumed that the perturbation signal τlₖ=τ(1−j) is added to the data signal sₖ (the triangle in the base lattice) for the k-th user terminal in the base station.

In the example shown in FIG. 3, the signal sₖ+τ(1−j) transmitted for the k-th user terminal from the base station is received by the black-colored triangle after the channel equating in the k-th user terminal. The modulo operation is to return the signal point in the base lattice in which the perturbation interval i is a basic unit. Accordingly, in the example shown in FIG. 3, the k-th user terminal obtains the reception signal y″ represented by the white-colored triangle in the base lattice by the modulo operation (shifting the reception signal y′ represented by the black-painted triangle by “it” in the minus direction on the real axis and by “lτ” in the plus direction on the imaginary axis). In the demodulation process of the k-th user terminal, to determine the triangle with the smallest distance as the transmission signal from the comparison between the reception signal y″ and the signal point candidate in the base lattice, the base station can accurately estimate the data signal sₖ transmitted for the k-th user terminal.

In the example shown in FIG. 4, the signal sₖ+τ(1−j) transmitted for the k-th user terminal from the base station is received by the black-colored triangle after the channel equating in the k-th user terminal. The reception signal y′ of the k-th user terminal is included in the lattice different from the latticed including the sₖ+τ(1−j). In the example shown in FIG. 4, the k-th user terminal obtains the reception signal y″ represented by the white-colored triangle in the base lattice by the modulo operation (shifting the reception signal y′ represented by the black-painted triangle by “lτ” in the plus direction on the imaginary axis). In the demodulation process of the k-th user terminal, to determine the rectangle with the smallest distance as the transmission signal from the comparison between the reception signal y″ and the signal candidate in the base lattice, the base station cannot accurately estimate the data signal sₖ transmitted for the k-th user terminal.

As described above, when the k-th user terminal receives the signal sₖ+τlₖ transmitted from the base station as the signal included in the lattice different from the lattice including the signal by the influence of a noise or the like, the perturbation signal τlₖ is not appropriately removed, and the transmission characteristics deteriorate.

As a countermeasure of such a modulo loss problem, the perturbation interval τ is not set by the method shown in Formula 18, but there is a method of setting the perturbation interval τ with a larger value. By increasing the sizes of the base lattice and the expansion lattice, it is possible to reduce probability of receiving the signal sₖ+τlₖ transmitted from the base station as the signal included in the lattice different from the lattice including the signal.

Meanwhile, as the perturbation interval τ is more increased than Formula 18, it is not easy to appropriately add the perturbation signal, and it is not easy to decrease the reciprocal number (value of γ) of the normalization coefficient. For example, in the VP method, when the perturbation interval τ is drastically large, l of Formula 11 becomes l=0, it is possible to obtain only the characteristics equivalent to the ZF method. As described above, performance of the VP method depends on the magnitude of the perturbation interval τ.

<Method of Determining Perturbation Interval>

The perturbation vector adder 102 determines the perturbation vector τl according to Formula 11 using the data signal 12(s) from the modulator 101, the perturbation interval information 17(τ) from the perturbation interval determining unit 110, and the weight matrix 15(W) from the weight calculator 109. The perturbation vector adder 102 adds the perturbation vector τl to the data signal 12(s) from the modulator 101, and outputs the signal s+τl to the weight multiplying unit 103.

In addition, the weight matrix 15(W) may be acquired by the ZF norm shown in Formula 4, and may be acquired by an MMSE norm shown in Formula 19.

W=H^{H}(HH^{H}+aI)⁻¹ (19)

“I” indicates a unit matrix. “a” indicates a parameter which can be arbitrarily set by an operator.

The perturbation interval determining unit 110 determines the perturbation interval information 17 (τ=β×τ_{b}: β is a real number equal to or more than 1) with reference to the Look-Up table from the perturbation interval determining signal 16.

The perturbation interval determining signal 16 is preferably information for determining the perturbation interval in the Look-Up table, and includes at least one of MCS (Modulation and Coding Scheme) when transmitting the data signal 12(s), the number of antennas used when transmitting the data signal 12(s), and the number of antennas used when the communication device STA receives the data signal 12(s).

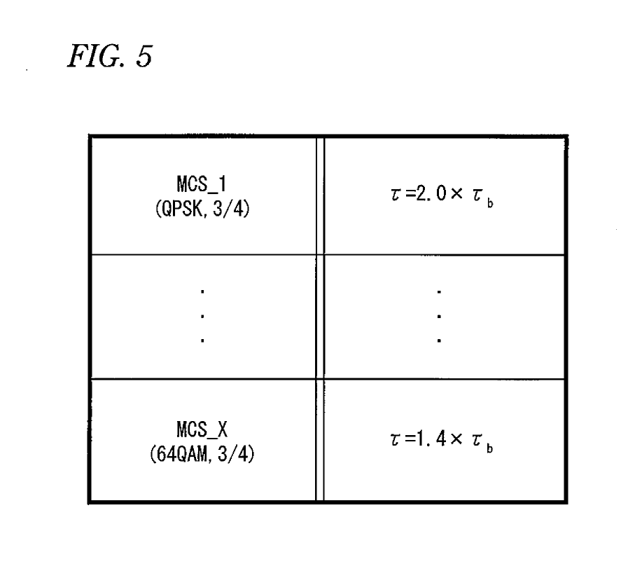

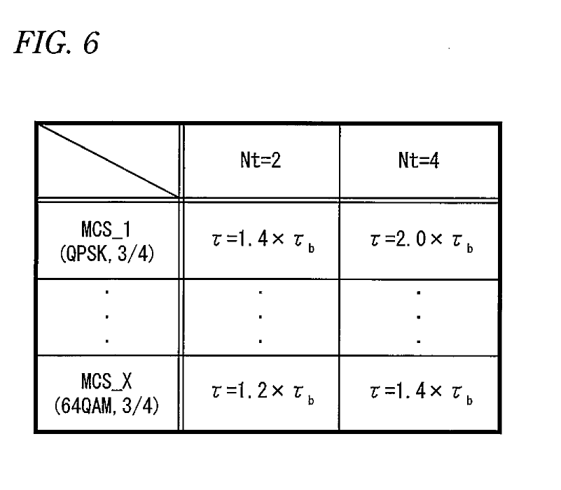

FIG. 5 and FIG. 6 are diagrams illustrating an example of the Look-Up table. FIG. 5 shows the perturbation interval τ according to the MCS when transmitting the data signal 12(s). FIG. 6 shows the perturbation interval τ according to the MCS when transmitting the data signal 12(s) and the number of antennas used when transmitting the data signal 12(s). The Look-Up table is stored in a storage unit (not shown) built in the perturbation interval determining unit 110. The Look-Up table is generated using the result obtainable by pre-evaluation. In the pre-evaluation when generating the Look-Up table, the perturbation interval defined in Formula 18 is the basic perturbation interval τ_{b}(=2(|c|ₘₐₓ+Δ/2)), and the perturbation ti is defined as shown in Formula 20.

τ=β×τ_{b} (20)

Herein, β is a positive real number equal to or more than 1, τ is a magnification value representing the magnification from τ_{b}.

The perturbation interval information 17 is preferably information for determining the basic signal, may be information representing τ as it is, and may be information representing β.

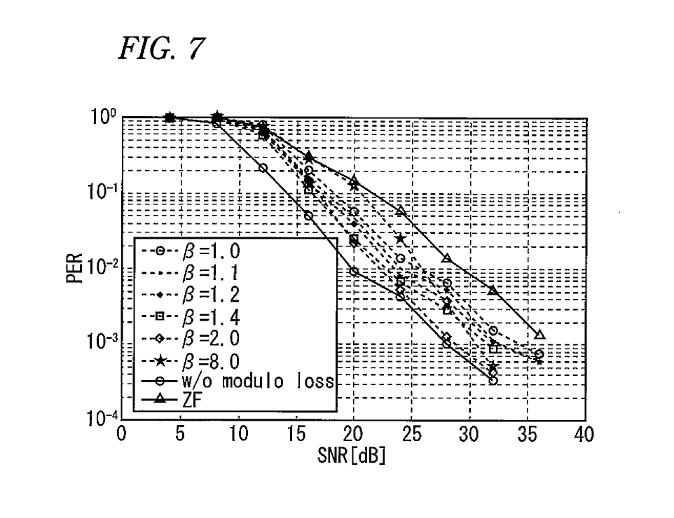

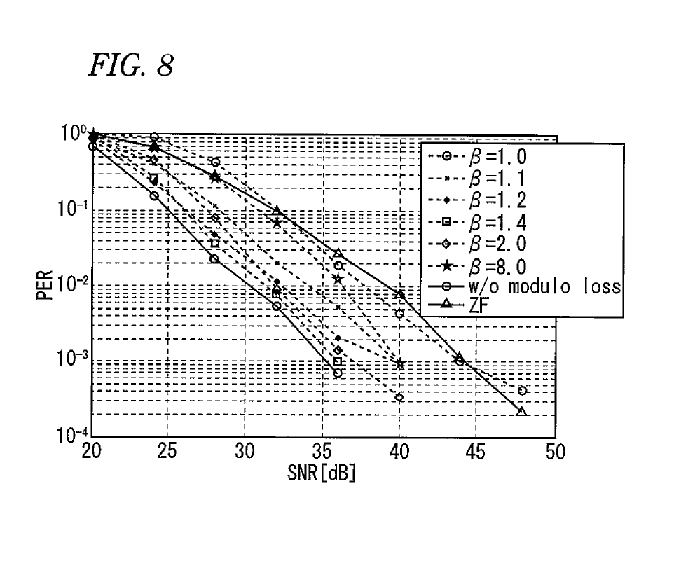

FIG. 7 and FIG. 8 are diagrams illustrating characteristics of a packet error rate. FIG. 7 and FIG. 8 show characteristics in which the magnitude value β is 1.0, 1.1, 1.2, 1.4, 2.0, and 8.0, characteristics (solid line, circular plot) when the user terminal completely recognizes the perturbation signal added to the base station and the modulo loss problem does not occur (hereinafter, referred to as ideal characteristics), and characteristics (solid line, triangular plot) when using ZF method. Herein, in the VP method, it is assumed that the number of reception side communication devices STA is 4, the number of antennas used by the transmission side communication device AP is 4, and the number of antennas used by the transmission side communication device STA is 1.

When using the modulation method QPSK of FIG. 7 and the encoding rate of 3/4, the characteristics of β=1.0 is better than the characteristics of the ZF method by PER=10⁻² level of about 5 dB, but it is worse than the ideal characteristics by about 5 dB. In the case of β=2.0, a performance difference from the ideal characteristics is about 2 dB, and it is closest to the ideal characteristics. Accordingly, in the situation shown in FIG. 7, the perturbation interval determining unit 110 determines the perturbation interval as τ=β(=2.0)×τ_{b} with reference to the Look-Up table.

When using the modulation method 64QAM of FIG. 8 and the encoding rate of 3/4, the characteristics of β=1.0 deteriorate by as much as there is little difference from the characteristics of the ZF method. However, in the case of β=1.4, the performance difference from the ideal characteristics is about 1 dB, and it is closest to the ideal characteristics. Accordingly, in the situation of FIG. 8, the perturbation interval determining unit 110 determines the perturbation interval as τ=β(=1.4)×τ_{b} with reference to the Look-Up table.

When the value of the perturbation interval τ get larger, the distance between the basic lattice and each expansion lattice gets larger, and it is possible to prevent a problem that the perturbation vector cannot accurately removed (modulo loss problem) due to the influence of a noise or the like, from occurring. However, the perturbation vector in the VP method is not appropriately performed. As a result, the value of the normalization coefficient cannot be sufficiently decreased.

In consideration of the fact described above and the characteristics shown in FIG. 7 and FIG. 8, the perturbation interval determining unit 110 appropriately sets the perturbation interval (magnitude of basic signal), thus the deterioration of the transmission characteristics caused by the modulo loss problem in the VP method is prevented from occurring, and it is possible to realize the performance close to the ideal characteristics. It is possible to improve the probability that the reception side communication device STA accurately removes the perturbation signal added by the transmission side communication device AP, without impairing the merit of improving the channel capacity by the VP method.

The Look-Up table is determined by performing pre-examination (simulation) for each communication device and user circumstance. However, for example, in number assignment of the number MCS, as the number gets larger, it is set to be the modulation method with large multi-value number or the high encoding rate, and it is possible to thereby set the magnification value β to be small as much as the number of the MCS is large. The reason is because it is assumed that the modulo loss problem does not easily occur even when the magnification value β is large, as it is a basis of determination that the number of the MCS is set large in the circumstance with satisfactory circumstances of the propagation characteristics (circumstance with satisfactory SNR).

The reception side communication device STA cannot remove the perturbation vector in the modulo operating unit 206 when the perturbation interval ti used in the perturbation vector adder 102 of the transmission side communication device AP is unknown. Accordingly, the perturbation interval determining unit 208 of the communication device STA determines the perturbation interval in the same method as the perturbation interval determining unit 110 of the communication device AR For example, the perturbation interval determining unit 208 of the communication device STA may generate the perturbation interval information 22 using the same Look-Up table as the communication device AP side and the perturbation interval determining signal 21.

When the frame transmitted to and received from the communication device AP and the communication device STA has a data signal and a control signal for demodulating and decoding the data signal, the reception side communication device STA may acquire information such as the MCS (modulation method and encoding rate) applied to the data signal by the communication device AP and the number of antennas used in the transmission by the communication device AP, from the control signal.

The control signal may include the perturbation interval (magnitude of basic signal) (for example, perturbation interval information 22) used when the transmission side communication device AP adds the perturbation signal to the data signal. In this case, the communication device STA may not be provided the perturbation interval determining unit 208, and the modulo operation unit 206 may remove the perturbation signal using the perturbation interval described in the control signal.

In a rising circuit transmitting the frame from the communication device STA to the communication device AP, the communication device STA may report the determined perturbation interval (for example, the perturbation interval information 22) to the communication device AP. In such a manner, the communication device STA recognizes the number of antennas of the communication device AP, but it is possible to determine the proper perturbation distance in consideration of the number of antennas of the communication device STA when the communication device AP does not recognize the number of antennas of the communication device STA. In addition, when the communication device AP does not recognize the number of antennas of the communication device STA, the communication device AP may determine the perturbation interval, assuming that the number of antennas of the communication device STA is “1” (the most basic configuration).

In the description described above, the communication device AP assigns one transmission stream to two user terminals (communication devices STA) using two transmission antennas. However, the transmission antennas of the communication device AP is increased, it may assign the plurality of transmission streams to the user terminals (communication device STA), and the number of user terminals (communication device STA) may be increased. When the number of reception antennas of the user terminal (communication device STA) is increased, the user terminal (communication device STA) considers the reception filter matrix used in the plurality of reception antennas, and then feeds back the channel information to the communication device AP.

In addition, the communication device AP may be realized as, for example, a semiconductor integrated circuit (chip). That is, the wireless unit 107-1, . . . , 107-Nt, the modulator 101, the perturbation vector adder 102, the weight transmitting unit 103, the normalization coefficient multiplying unit 104, the Nt inverse fast Fourier transform units 105-1, . . . , 105-Nt, and the GI adders 106-1, . . . , 106-Nt may be realized by one or more semiconductor integrated circuits. One or more semiconductor integrated circuits perform the input and output of external signals (antenna, other semiconductor integrated circuit, wireless unit, firmware, and the like) through connector pins.

In addition, the communication device STA may be realized as, for example, a semiconductor integrated circuit (chip). That is, the antenna 201, the wireless unit 202, the GI removing unit 203, the fast Fourier transform unit 204, the channel equalizer 205, the modulo operating unit 206, the demodulator 207, and the perturbation interval determining unit 208 may be realized by one or more semiconductor integrated circuits. One or more semiconductor integrated circuits perform the input and output of external signals (antenna, other semiconductor integrated circuit, wireless unit, firmware, and the like) through connector pins.

In addition, the communication devices AP and STA may be provided with both of the processing unit for the transmission process shown in FIG. 1 and the processing unit for the reception process shown in FIG. 2. The antenna, the wireless unit, the Fourier transform unit (inverse Fourier transform unit), and the like may be used for both usages even when having only one of the transmission process and the reception process.

### Other Embodiment

Embodiments of the invention are not limited to the above-described embodiment, but may be expanded and modified, and the expansion and modification are also included in the technical scope of the invention.

Although the several embodiments of the invention have been described above, they are just examples and should not be construed as restricting the scope of the invention. Each of these novel embodiments may be practiced in other various forms, and part of it may be omitted, replaced by other elements, or changed in various manners without departing from the spirit and scope of the invention. These modifications are also included in the invention as claimed and its equivalents.

What is claimed is:

1. A communication device for adding a first perturbation signal corresponding to an integer multiple of a first basic signal, to a first information signal having information, which is to be transmitted to a destination terminal by a spatial multiplexing method, the device comprising:
a determination unit configured to set a magnitude of the first basic signal to N time of one side of a basic lattice, wherein the basic lattice is determined according to a modulation method of the first information signal, and N is real number of one or more;
an adder to add the first perturbation signal to the first information signal so as to output a second information signal; and
a multiplier to multiply the second information signal by a weight.

2. The device according to claim 1, wherein the determination unit is configured to determine the magnitude of the first basic signal based on the modulation method and an encoding rate of the first information signal.

3. The device according to claim 2, wherein the determination unit is configured to determine the magnitude of the first basic signal, based on the modulation method and the encoding rate of the first information signal, and the number of transmission antennas for transmission of the wireless signal.

4. The device according to claim 1, further comprising:
a receiver to receive information about the magnitude of the first basic signal from the destination terminal,
wherein the determination unit is configured to determine the magnitude of the first basic signal based on the information received by the receiver.

5. The device according to claim 1, further comprising:
a transmitter to transmit a wireless signal including the first information signal and information about the magnitude of the first basic signal.

6. The device according to claim 1, further comprising:
a plurality of antennas; and
a transmitter to transmit the first information signal to the destination terminal through the plurality of antennas.
